(19) United States
(12) Patent Application Publication
(10) Pub. No.: US 2003/0001016 A1
(43) Pub. Date: Jan. 2, 2003

(54) Apparatus and method for accessng multimedia content

(76) Inventors: Israel Fraier, Lehavim (IL); Yuri Magrisso, Beer-Sheva (IL); Sagi Cooper, Rosh Ha'ain (IL)

Correspondence Address: Omrad Opto Electronics, PO Box 10347, Beer-Sheva, 84003, IL

(21) Appl. No.: 10/182,254

(22) PCT Filed: Jan. 26, 2001
(86) PCT No.: PCT/IB01/00269

(51) Int. Cl. G06K 7/10; G06K 19/06

(52) U.S. Cl. 235/462.03

(57) ABSTRACT

An apparatus and method for accessing multimedia content using physical bookmarks are provided. The apparatus for accessing multimedia content using physical bookmarks includes one or more tokens. Each of the tokens associated with an identification code, wherein the identification code is associated with a multimedia content. The apparatus also includes an input device having a receptacle. The input device is operable to receive a first identification code from a first token placed on the receptacle in an arbitrary angular orientation. A processing component is coupled to the input device and operable to receive the first identification code, and operable to deliver a first multimedia content associated with the first identification code. The method includes detecting a token that is placed on a receptacle of an input device by a user, wherein the token has an identification code. The method also includes reading the identification code associated with the token, and transmitting the identification code to a content server. The method further includes receiving a multimedia content identified by the identification code from the content server, and delivering the multimedia content to the user.

### CLAIM FOR PRIORITY

This application claims the benefit of priority under 35 U.S.C. §119(e) of U.S. Provisional Application No. 60/178,637 filed on Jan. 28, 2000, and U.S. Provisional Application No. 60/213,223 filed on Jun. 19, 2000. Each of the above referenced patent applications are incorporated herein by reference in their entireties.

### BACKGROUND

1. Field

The present invention relates generally to computer systems, and more specifically, to an apparatus and method for accessing multimedia content.

2. Description of the Related Art

Companies are continuously searching for new ways of advertising and promoting their products. Many conventional marketers, mainly those for children, distribute tokens and giveaways (i.e., premiums) in an attempt to attract consumers' attention. In many cases, the tokens have no significant entertainment, educational, or informative value.

The advent of the Internet and the World Wide Web (WWW), in addition to the recent advances in personal computer (PC) technology have transformed the WWW into a viable advertising and promotion mechanism. For example, advertising and promotional materials in the form of multimedia content is made available to consumers and potential consumers on the Internet. Devices such as, by way of example, PCs, televisions (TVs), digital TVs, Web TVs, and other types of post-PC digital appliances capable of connecting to the Internet are used to access the source of information. These devices typically provide a user interface, including input/output devices (i.e., keyboard, mouse, display, etc.) used to interact with the user interface, that allows its user to navigate to and obtain the information.

However, conventional user interfaces and the input/output devices are not suitable for all users. A considerable number of users may experience problems in working with these devices. These conventional user interfaces and input/output devices are not suitable for persons with limited capabilities such as, by way of example, little children or disabled persons (e.g., blind, handicapped, etc.). For example, little children may not be able to input, using a keyboard, a Uniform Resource Locator (URL) that addresses the location of the multimedia content desired by the child. A blind person may also encounter difficulties in inputting a correct URL using a keyboard.

There exists a need that allows people with limited capabilities to intuitively access and benefit from the vast amounts of multimedia content that is available on the Internet. Furthermore, current devices and methods used to access the multimedia content on the Internet are unsuitable for companies wanting to market information, entertainment, promotion, education, games, and the like, by distributing tokens and giveaways. Thus, what is desirable is a method for providing intuitive access to the multimedia content through the use of the tokens and giveaways currently used to attract the consumers' attention.

### SUMMARY

The disadvantages and problems associated with previously developed systems and techniques for providing access to multimedia content have been substantially reduced or eliminated by the present invention.

One embodiment of the present invention provides an apparatus and method for intuitively accessing multimedia content using physical bookmarks. The apparatus includes a play unit that is coupled to a PC or other digital appliance. The play unit is configured to read or receive as input an identification code from a token, such as, by way of example, a toy, a figurine, a game token, a token attached to a toy or figurine, a bottle cap, or other promotional device. The token may be of arbitrary size and shape, and may be made of materials that provide a sensory sensation.

For example, the play unit reads the identification code when a user places the token on the play unit in a position that enables the play unit to read the identification code. In one embodiment, the token may be placed on the play unit in any arbitrary angular orientation. The play unit transmits the identification code to the coupled PC or digital appliance. The identification code is used as a factor in determining multimedia content that is subsequently delivered through the PC or digital appliance (e.g., the multimedia content is displayed on a display device coupled to the PC or digital appliance, the multimedia content is audibly broadcast through a speaker coupled to the PC or digital appliance, etc.). Thus, a technical advantage of the present invention includes providing an apparatus and method in which a token functions as a “physical bookmark” to multimedia content associated with the token. The token may be used in any arbitrary angular orientation to intuitively provide access to multimedia content associated with the token.

In one embodiment, a software program executing on the PC or digital appliance receives the identification code from the play unit. The software program transmits the identification code, for example, via a network connection to a physical bookmark server. The physical bookmark server then determines the multimedia content associated with the identification code. The identified multimedia content is transmitted to the PC or digital appliance for delivery to a user. In another embodiment, the software program executing in the PC or digital appliance identifies the multimedia content associated with the identification code and subsequently delivers the appropriate multimedia content to the user.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

In one embodiment, an apparatus for accessing multimedia content using physical bookmarks includes one or more tokens. Each of the tokens comprises an identification code, wherein the identification code is associated with a multimedia content. An input device having a receptacle is operable to receive a first identification code from a first token placed on the receptacle in an arbitrary angular orientation. A processing component is coupled to the input device and operable to receive the first identification code, and operable to deliver a first multimedia content associated with the first identification code.

In another embodiment, a polygonal barcode includes one or more barcodes. The polygonal barcode is substantially shaped as a polygon, with each of the one or more barcodes being placed inside one of the one or more triangles of the polygonal barcode. Each of the one or more triangles is created from the polygon wherein a first side of each triangle extends from the center of the polygon to a first vertex of the polygon and a second side of each triangle extends from the center of the polygon to a second vertex of the polygon and a base of each triangle extends along a first side of the polygon.

In still another embodiment, a system for associating an identification code of a physical bookmark token to a multimedia content includes a database having one or more mappings. Each of the one or more mappings includes a mapping of an identification code to an identifier associated with a multimedia content, wherein the identification code is associated with a token. A module coupled to the database is operable to receive a first identification code and determine a first identifier mapped to the first identification code. The module further operable to retrieve a first multimedia content associated with the first identification code and to provide the first multimedia content.

In a further embodiment, a method for creating physical bookmarks includes: providing a user identification to a physical bookmark server, the user identification identifies a user of the physical bookmark server; specifying a URL; placing a token in a position to be read by an input device, the token being associated with an identification code, wherein the input device receives and transmits the identification code to the physical bookmark server; and requesting an association between the identification code and the user identification and the URL.

In still a further embodiment, a method for selecting and accessing multimedia content via physical bookmarks includes: detecting a token placed on a receptacle of an input device by a user, the token having an identification code; reading the identification code associated with the token; transmitting the identification code to a content server; receiving a multimedia content from the content server, the multimedia content being identified by the identification code; and delivering the multimedia content to the user.

In yet a further embodiment, a method for providing multimedia content associated with an identification code of a physical bookmark includes: providing a database having one or more mappings, each of the one or more mappings having a mapping of an identification code to an identifier associated with a multimedia content, wherein the identification code is associated with a token; receiving a first identification code; determining from the database a first identifier mapped to the first identification code; retrieving a first multimedia content associated with the first identification code; and providing the first multimedia content.

In one embodiment, a method for providing tokens associated with multimedia content includes: obtaining an identification code from a physical bookmark server provider; registering the identification code with the physical bookmark server provider, the physical bookmark server provider indicating the identification code as active; specifying to the physical bookmark server provider an identifier to associate with the identification code, the identifier being a reference to a multimedia content, wherein the physical bookmark server provider creates an association between the identifier and the identification code; affixing the identification code to one or more tokens; and distributing the one or more of tokens.

These and other embodiments of the present invention will also become readily apparent to those skilled in the art from the following detailed description of the embodiments having reference to the attached figures, the invention not being limited to any particular embodiment(s) disclosed.

### BRIEF DESCRIPTION OF THE DRAWINGS

FIG. 1 is a diagram illustrating an environment in which a physical bookmark of the present invention may operate.

FIG. 2A is a representation of one embodiment of an exemplary play unit.

FIG. 2B is a representation of one embodiment of an exemplary receptacle keyed to receive a polygonal-shaped object.

FIG. 3 illustrates selected components of a play unit, according to one embodiment.

FIG. 4A is a representation of one embodiment of an exemplary token bearing a barcode.

FIG. 4B is a representation of another embodiment of an exemplary token bearing a barcode.

FIGS. 5 illustrates an exemplary polygonal barcode, according to one embodiment.

FIGS. 6A to 6D illustrate exemplary associations between identification codes and multimedia content, according to one embodiment.

FIG. 7 illustrates an exemplary user interface for children, according to one embodiment.

FIG. 8 illustrates a flow chart of an exemplary method by which a physical bookmark is created, according to one embodiment.

FIG. 9 illustrates selected components of a physical bookmark server, according to one embodiment.

FIG. 10 illustrates a flow chart of an exemplary method by which a physical bookmark server identifies content associated with a physical bookmark, according to one embodiment.

FIG. 11 illustrates a flow chart of an exemplary method by which a user creates a physical bookmark, according to one embodiment.

### DETAILED DESCRIPTION

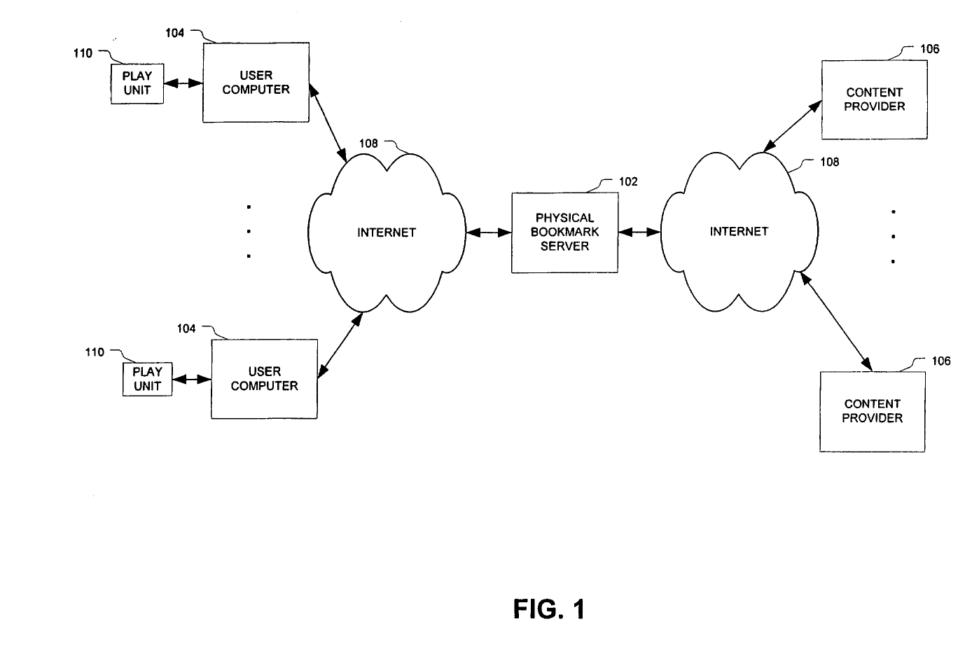

FIG. 1 illustrates an environment in which a physical bookmark according to one embodiment may operate. The environment includes a physical bookmark server 102 connected to a network (e.g., the Internet) 108. Also connected to the Internet 108 are one or more user computers 104 and one or more content providers 106. Connected to each of the user computers 104 is a play unit 110. As used herein, the terms “connected,” “coupled,” or any variant thereof, means any connection or coupling, either direct or indirect, between two or more elements; the coupling or connection between the elements can be physical, logical, or a combination thereof.

In one embodiment, the physical bookmark server 102 and one or more content providers 106, either independently or in conjunction comprise a content server. As used herein, the terms “physical bookmark server,” “content provider,” and “content server” are to be viewed as designations of one or more computers and are not to be otherwise limiting in any manner. The computers for the physical bookmark server 102, the content provider 106, and the user computer 104 may be the same or different. The physical bookmark server 102 may, for example, be comprised of one or more program modules that execute on one or more computers. As another example, the functionality provided by the physical bookmark server 102 and the content provider 106 as described herein may be implemented as one or more program modules that execute on the user computer 104. Furthermore, the physical bookmark server 102 need not be server based, but can comprise one or more modules that execute on one or more computers.

A computer, including the user computers 104, and the computers comprising the physical bookmark server 102 and the content providers 106, may be any microprocessor or processor (hereinafter referred to as processor) controlled device such as, by way of example, personal computers, workstations, servers, clients, mini-computers, main-frame computers, laptop computers, a network of one or more computers, mobile computers, portable computers, handheld computers, palm top computers, set top boxes for a TV, interactive televisions, interactive kiosks, personal digital assistants, interactive wireless devices, mobile browsers, or any combination thereof. The computer may possess input devices such as, by way of example, a keyboard, a keypad, a mouse, a microphone, or a touch screen, and output devices such as a computer screen, printer, or a speaker. Additionally, the computer includes memory such as a memory storage device or an addressable storage medium.

The computer may be a uniprocessor or multiprocessor machine. Additionally the computer, and the computer memory, may advantageously contain program logic or other substrate configuration representing data and instructions, which cause the computer to operate in a specific and predefined manner as, described herein. The program logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro-code, circuitry, data, and the like.

The program logic conventionally includes the manipulation of data bits by the processor and the maintenance of these bits within data structures resident in one or more of the memory storage devices. Such data structures impose a physical organization upon the collection of data bits stored within computer memory and represent specific electrical or magnetic elements. These symbolic representations are the means used by those skilled in the art to effectively convey teachings and discoveries to others skilled in the art.

The program logic is generally considered to be a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, records, files, or the like. It should be kept in mind, however, that these and some other terms should be associated with appropriate physical quantities for computer operations, and that these terms are merely conventional labels applied to physical quantities that exist within and during operation of the computer.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general purpose computing machines or devices may be used with programs constructed in accordance with the teachings described herein. Similarly, it may prove advantageous to construct a specialized apparatus to perform the method steps described herein by way of dedicated computer systems with hard-wired logic or programs stored in non-volatile memory, such as, by way of example, read-only memory (ROM).

The physical bookmark server 102 facilitates the association of a physical bookmark or “token” to a multimedia content, identification and retrieval of a multimedia content identified by or associated with an identification code, and the subsequent delivery and presentation of the multimedia content to a user. “Physical bookmark” and “token” are used interchangeably herein. “Physical bookmark” or “token” here generally refers to physical devices that may be used intuitively to access multimedia content that provides educational and/or entertainment (hereinafter referred to as “edutainment”) value. The physical bookmark has associated or affixed an identification code that identifies a multimedia content associated with the particular physical bookmark.

In one embodiment, the identification code is a machine-readable code that is read by the play unit 110. For example, a user of a token (e.g., parent, child, toddler, or any other person in possession of the physical bookmark) places the token on the play unit 110 to enable the play unit 110 to read the identification code of the token. The play unit 110 transmits the identification code to a program module that causes the subsequent delivery and presentation of the associated multimedia content to the user. The play unit 110 is further described below.

In one embodiment, a token may be a promotional product or a marketing premium. A token may, for example, be a toy, a figurine, a game piece or part, a packaging part, a bottle cap, a playing card, etc. that is attached to or otherwise associated with a consumer product or service. The token's physical characteristics (e.g., association to an identifiable consumer product or service) and the ease with which the token is placed upon the play unit 110 makes the token an easy-to-distinguish physical bookmark that is useable by unskilled computer users.

For example, an entity, such as, by way of example, a manufacturer, a distributor, a service provider, a product provider, or an advertiser, may distribute the play unit 110, including the software programs and components (e.g., the components necessary to couple the play unit 110 to the user computer 104 and the program modules that execute on the user computer 104) needed to make the play unit 110 operable, and one or more tokens to users for free or at a substantially reduced price. The tokens may also be distributed to users through various distribution channels independent of the play unit 110. In another embodiment, one or more tokens may be included as part of, for example, a board game and distributed and sold along with the board game.

A token may readily be identifiable with a provider or supplier (e.g., product manufacturer, service provider, etc.) of the token and the identification code associated with the token may provide access to multimedia content that is also identifiable with the provider or supplier of the token and/or the token itself. For example, an amusement park may be a provider of tokens shaped in the form of the amusement park's popular characters. The tokens may further be associated or affixed with an identification code that is subsequently used to identify, for example, multimedia content which features a story about the character represented by the token. The multimedia content may also be appropriate and safe for access and reception by children, the likely users of these tokens.

The tokens, independently or along with the play unit 110, may then be distributed to users at the amusement park or through other distribution channels.

A technical advantage of one embodiment includes providing a marketing vehicle for establishing a lasting communication channel between the provider of a token and the user of the token. The provider of the token may create and distribute tokens that represent popular and sought after characters and objects. Furthermore, the token may provide edutainment to its user in providing access to educational or entertaining multimedia content. The token may also provide an edutainment value to its user independent of the multimedia content. For example, the token may belong to a collection of tokens that is desired and collected by users. Users are inclined to obtain and user the token because of the token's edutainment value and properties. For example, the user may use the token to access the associated multimedia content because it is edutaining. The user may even repeatedly use the token over extended periods of time. Because the provider of the token controls the multimedia content that is accessed by use of the token, the token provider is able to deliver and present additional content (e.g., promotional content, advertising content, etc.) along with the edutainment content, and thus, establish an effective communication channel to the users of its token. The provider of the token may expire the content in such a way to induce a repeat XV sit to the token provider's outlet (e.g., game demonstrations, repeat visits to McDonald's, etc.).

The play unit 110 can be used to determine the right to play a certain piece of multimedia that requires purchasing (i.e., the identification associated with a song or a video file available on the Internet is playable only after its price has been paid). The token may be duplicated repeatedly, but payment is required by a user of the play unit 110 in order to access the content associated with the token Without payment, the token provides no value to the user. A sponsor may make the payment for the user.

In one embodiment, the physical bookmark server 102 contains the necessary data and program logic to facilitate the identification, retrieval, and transmission of a multimedia content that is associated with an identification code to a user. A provider of a token (e.g., a manufacturer, service provider, product provider, etc.) may administer and provide the physical bookmark server 102. Alternatively, an entity other than the token provider such as, by way of example, a provider of computer services, may administer the physical bookmark server 102 and provide the physical bookmark services as disclosed herein to a provider of a token. The physical bookmark server 102 maintains data such as, by way of example, registered user information, user preference information, identification codes, mappings between identification codes and identifiers that identify the multimedia content, thus creating an association between the identification code and the multimedia content, and other data necessary to provide the physical bookmark features and functions as disclosed herein.

In one embodiment, the physical bookmark server 102 contains one or more modules that receive, for example, over the Internet 108 an identification code and optionally, user information (e.g., user login information) from a user computer 104. The physical bookmark server 102 processes the received information to identify necessary user preference information and the multimedia content associated with the received identification code. The physical bookmark server 102 retrieves the appropriate multimedia content, for example, from a content provider 106 or from a local copy of the multimedia content maintained on the physical bookmark server 102, and transmits the multimedia content to the requesting user computer 104.

The Internet 108 facilitates the transfer and transmission of electronic content, including the multimedia content. The Internet 108 is a global network connecting millions of computers, including the user computer 104, physical bookmark server 102, and content provider 106. The structure of the Internet 108, which is well known to those of ordinary skill in the art, is a global network of computer networks and utilizes a simple, standard common addressing system and communications protocol known as Transmission Control Protocol/Internet Protocol (TCP/IP). The connections between different networks are called “gateways,” and the gateways serve to transfer electronic data worldwide.

One part of the Internet 108 is the World Wide Web (WWW or Web). The Web is generally used to refer to both (1) a distributed collection of inter-linked, user-viewable hypertext documents (commonly referred to as “web documents” or “web pages” or “electronic pages” or “home pages”) that are accessible via the Internet 108, and (2) the client and server components which provide a user access to such documents (e.g., electronic content, multimedia content, etc.) using standardized Internet 104 protocols. The web documents are encoded using Hypertext Markup Language (HTML) and the primary standard protocol for allowing the components to locate and acquire web documents is the Hypertext Transfer Protocol (HTTP). However, as used herein, the term Web is intended to encompass future languages and protocols, which may be used in place of, or in addition to, HTML and HTTP.

One of ordinary skill in the art will appreciate that the Internet 108 may advantageously be comprised of one or a combination of other types of networks without detracting from the scope of the invention. The Internet 108 can include, by way of example, local area networks (LANs), wide area networks (WANs), public internets, private intranets, a private computer network, a secure internet, a private network, a public network, a value-added network, interactive television networks, wireless data transmission networks, two-way cable networks, satellite networks, interactive kiosk networks, and/or any other suitable data network.

The content provider 106 generally functions to store and provide the multimedia content to, for example, the physical bookmark server 102. The content provider 106 contains the program logic to receive, for example, from the physical bookmark server 102 over the Internet 108 a request to access and obtain a multimedia content. The content provider 106 retrieves the requested multimedia content (e.g., a multimedia content identified by an identifier received from the physical bookmark server 102) and transmits the multimedia content to the requestor.

The user computer 104 generally functions as a device used by a user to request multimedia content associated with a token. In one embodiment, the user computer 104 contains program logic (e.g., one or more client applications) to receive an identification code associated with the token from a coupled play unit 110. The user computer 104 then requests a multimedia content associated with the received identification code, receives the requested multimedia content, and delivers the multimedia content to the user. Multimedia content delivery to the user may include, by way of example, display of the multimedia content on a display device coupled to the user computer 104, delivery of the multimedia content through a speaker coupled to the user computer 104, and other presentation of the multimedia content to the user through devices coupled to the user computer 104.

In one embodiment, the user computer 104 contains program logic to determine one or more preferences of a user that is using the user computer 104 to access multimedia content associated with a physical bookmark. The user computer 104 may additionally contain one or more user interface programs (e.g., browser programs) that facilitate the delivery of the multimedia content to the user. For example, the user computer 104 may contain one or more user interface programs that function to display the requested multimedia content on the user computer 104. One user interface program may permit the user to navigate to and access other multimedia content independent of the displayed multimedia content. Another user interface program may not provide the user the ability to navigate to and access multimedia content other than the displayed multimedia content or related multimedia content that is accessible through the displayed multimedia content, for example, through embedded hyperlinks in the displayed multimedia content.

The user computer 104 may contain program logic to determine the user interface that is appropriate for a particular user. In one embodiment, the program logic may request information regarding the user through one or more prompts. The program logic may then determine the appropriate user interface from the user's response or lack of response to the prompts. For example, the program logic may inquire as to whether the user is able to read.

If the user answers “no” or fails to answer within a preset time period, the program logic may determine that a user interface providing restricted access (e.g., no access to multimedia content independent of the requested multimedia content) is appropriate for the user. If, the user responded “yes” to the inquiry, the program logic may determine that a more functional user interface is appropriate for the user.

In one embodiment, the user computer 104 may contain program logic to facilitate the creation of one or more user accounts with the physical bookmark server 102. The physical bookmark server 102 creates a default user account for each play unit 110. The physical bookmark server 102 may create the default user accounts, for example, when the play units 110 are distributed, when the play units 110 are created, when the play units 110 are installed and coupled to the user computers 104, or when the play units 110 are first used to access multimedia content associated with a physical bookmark. The default user account may be identified by a unique identification associated with each play unit 110. A user may then use the program logic to create one or more user accounts, in addition to the default user account, for his or her play unit 110.

Subsequently, the default user account may be used in instances where a user uses the play unit 110 without previously logging on to the physical bookmark server 102 (e.g., a small child or unskilled computer user). If a user first logs on to the physical bookmark server 102 using a valid user account prior to using the play unit 110, the active user account, including any user account preferences and parameters, may be considered in delivering the requested multimedia content to the user.

In one embodiment, the user computer 104 may contain program logic to facilitate the inputting or entering of user information associated with a user account in the physical bookmark server 102. The program logic may be implemented as one or more wizards or prompts that assist a user in specifying user information, such as, by way of example, user data (e.g., name, address, phone number, etc.), user preference data (e.g., preferred language, favorite colors, favorite food, preferred music styles/groups/bands, spot games/teams, “yes” or “no” for the use of “cookies”, etc.), user statistical data (e.g., age, sex, language, etc.), user login (e.g., username and password), content filtering information (e.g., identification of the type of multimedia content to filter), community rights information (e.g., specification of the community services that are permitted and/or prohibited for the user account), and the like. Each user account may be associated with its own user information. Preference data may be used to increase a user's experience wit the system. For example, a web page can be dynamically built with a color scheme that complies with the user's favorite colors.

For example, a parent having two children (a toddler and a teenager) may have created three user accounts (e.g., the default user account for the toddler, one user account for the teenager, and another user account for the parent) a with the physical bookmark server 102. The parent may specify user information for each of the three user accounts. For example, the parent may specify filtering information that restricts the toddler's user account (the default user account) to only multimedia content that is rated or deemed “safe” for children. For the teenager's user account, the parent may specify, in addition to not permitting access to adult content, that the user account is not to grant access to community services intended for adults.

In one embodiment, the user information is maintained on the physical bookmark server 102. In another embodiment, the user information may be maintained on the user computer 104 and transmitted to the physical bookmark server 102 as required. In still another embodiment, some of the user information may be maintained on the physical bookmark server 102 and other of the user information maintained on the user computer 104. For example, user information that is sensitive or private (e.g., credit card information, etc.) may be maintained on the user computer 104 and transmitted to the physical bookmark server 102 as necessary.

Those of ordinary skill in the art will appreciate that some or all of the functions provided by the physical bookmark server 102 may be implemented as one or more modules operable to execute on the user computer 104. Furthermore, the functions and multimedia content provided by the content provider 106 may also be implemented on the user computer 104. For example, the multimedia content may be stored on one or more memory devices (e.g., compact disks (CDs), digital video disks (DVDs), memory sticks, etc.) that may be read by devices coupled to the user computer 104. The program logic to identify the multimedia content associated with an identification code may be implemented as one or more modules executing on the user computer 104. Thus, the apparatus and corresponding methods for providing multimedia content using a physical bookmark may be implemented as an integrated application that executes on the user computer 104.

As one example, the multimedia content may be stored on a CD that is inserted in a CD drive coupled to the user computer 104. As another example, the user computer 104 may be a TV. A DVD player may be coupled to the TV and a play unit 110, and a DVD disk containing the multimedia content may be inserted in the DVD player. The TV or the DVD player may contain program logic and components to facilitate the functions necessary to process the reading of a physical bookmark, the retrieval of a multimedia content associated with the physical bookmark from the DVD disk, and the display of the multimedia content on or through the TV. Other configurations of electronic devices, storage devices, and communication devices working in conjunction with the play unit 110 and the physical bookmarks as disclosed herein are envisioned.

The play unit 110 generally functions as an input device that facilitates the reading of an identification code from a token and the transmission of the identification code to a coupled user computer 104. In one embodiment, the play unit 110 contains components and necessary program logic to detect a placement of a token on the play unit 110, to receive or read an identification code from the detected token, and to transmit the identification code to a coupled user computer 104 for processing.

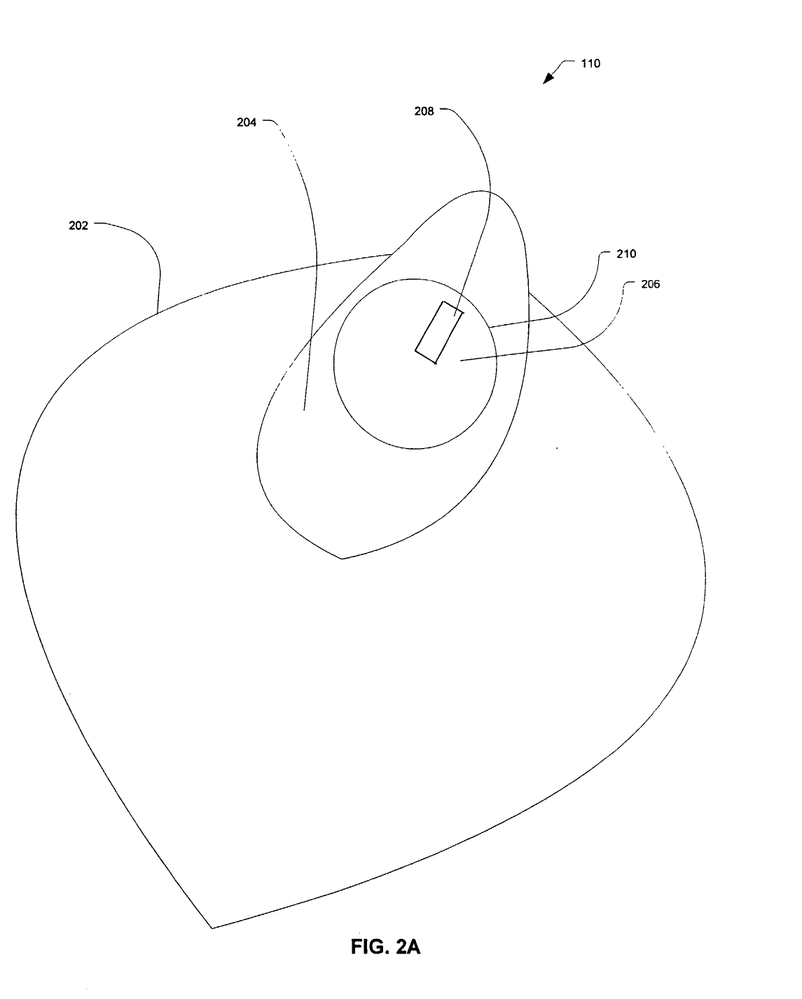

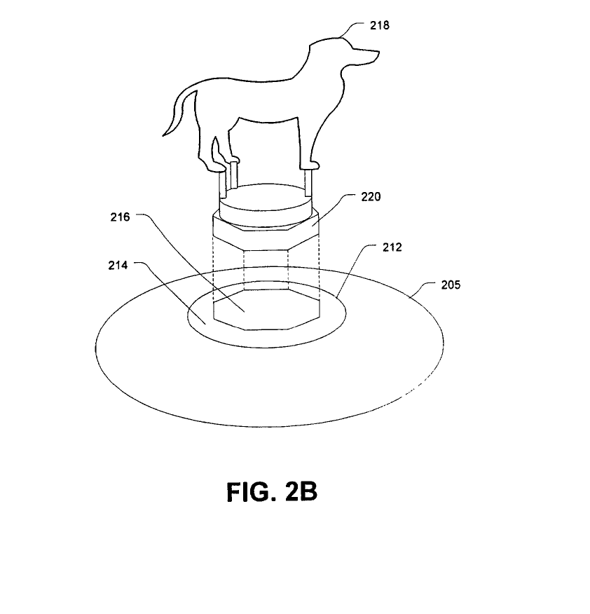

FIG. 2A is a representation of one embodiment of an exemplary play unit 110. As depicted, the play unit 110 includes a play unit housing 202, a receptacle 204, and a code reader 206 having a code reader window 208. The play unit housing 202 generally functions as a support structure for the receptacle 204, the code reader 206, and the code reader window 208. The play unit housing 202 includes an area where the receptacle 204 and the code reader 206, including the code reader window 208, may be operably mounted.

The receptacle 204 includes a border 210 that defines an area, for example, a cavity, where a user places a token for reading by the play unit 110. As depicted in FIG. 2A, the border 210 defines a substantially circular shaped cavity operable to receive a circular shaped token or a circular shaped portion of the token of substantially the same size as the circular shaped cavity. The substantially circular cavity enables, for example, the placement of a token having a circular base of substantially the same size as the cavity to be placed in the cavity in an arbitrary angular orientation. Thus, a user with limited motor skills, such as, by way of example, a small child or a handicapped person, can easily place a token having a circular portion of substantially the same or smaller size in the receptacle 204. In one embodiment, the receptacle 204 is detachable from the play unit housing 202, thus enabling other detachable receptacles 204 to be operably mounted on the play unit housing 202. Thus, the play station housing 202 may operably support receptacles 204 having cavities of different shapes and sizes that are suitable for use with tokens of substantially similar shapes and sizes.

The code reader 206 generally functions to read the identification code from a token operably placed within the receptacle 204. In one embodiment, the code reader 206 is a barcode reader operable to read a barcode affixed to the area on a token that is operably placed on the receptacle 204, and in particular, the cavity defined by the border 210. As depicted in FIG. 2A, the code reader 206 is operably positioned below the receptacle 204 in the play unit housing 202. The code reader window 208 is operably positioned at the base of the cavity of the receptacle 204, thus enabling the code reader 206 to read, through the code reader window 208, an identification code affixed to a token placed within the receptacle 204 cavity.

In another embodiment, a positioning mechanism, such as, by way of example, a needle, a pole, a stile, etc., is set on the receptacle 204 to enable a token having a cavity (e.g., a hole) to be properly positioned on the receptacle 204. For example, the token, and in particular, the cavity of the token, is placed to fit on the positioning mechanism. The positioning mechanism guides the token into an operable position for reading by the play unit 110. The positioning mechanism may be a polygonal central pole having a conical tip that guides the token into a predefined position. In still another embodiment, the positioning mechanism may be a cavity on the side wall of the receptacle 204 and a “tongue” on the token, and visa versa.

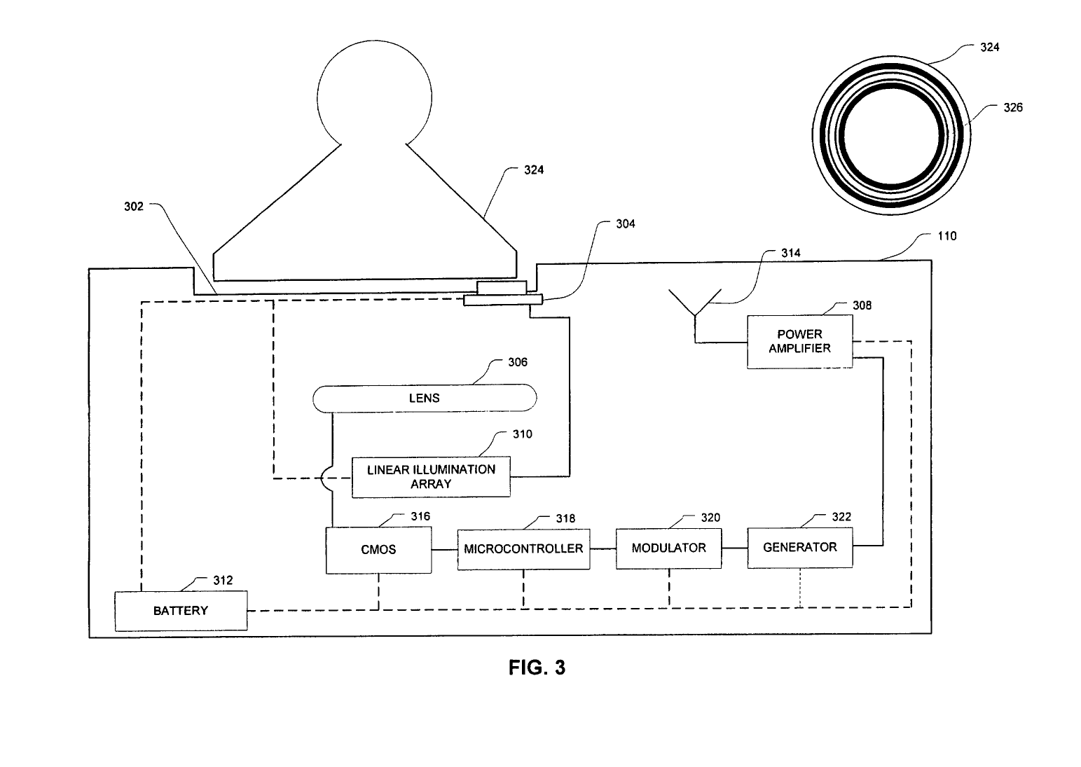

In one embodiment, the code reader 206 comprises an electro-optic (also referred to as optoelectronic) sensor. The electro-optic sensor is a sensor that converts light into an electronic signal. A linear electro-optic sensor may be a linear array of, for example, discrete photo-diodes, photo-transistors, a linear CMOS or CCD chip, having a number (e.g., N) pixels or sensor elements. The electro-optic sensor is further described below in conjunction with FIG. 3.

In another embodiment, the code reader 206 may comprise an area electro-optic sensor. An area electro-optic sensor is a two-dimensional array of light sensing elements, which results in an output of, for example, N×N pixels. Examples of area electro-optic sensors include a TV camera tube in a video camera and a CCD or CMOS single chip imaging sensor commonly used in the solid state video cameras and electronic still cameras.

In one embodiment, the code reader 206 is detachable from the play unit housing 202. The detachable code reader 206 may then be used as a portable device to read identification codes affixed to tokens without requiring the token to be placed on the receptacle 204. For example, a user may use the detachable code reader 206 to read identification codes affixed to tokens that are not suitable for placing on the receptacle 204 or tokens that are not shaped to fit within the receptacle 204 cavity. The play unit housing 202 may operably support code readers 206 having code reader windows 208 which are of varying shapes and which are oriented in differing positions. Furthermore, the play unit housing 202 may operably support detachable code readers 206, such as, by way of example, a laser scanner of the type available from Symbol Technologies, USA, or an RFID reader (i.e., BiSatix available from Motorola) for an RFID tag marked on tokens.

FIG. 2B is a representation of one embodiment of an exemplary receptacle 205 keyed to receive a polygonal-shaped object. As depicted, the receptacle 205 includes a substantially circular cavity opening 212 having tapered sides 214 which lead to a polygonal shaped base 216. The polygonal shaped base 216 is in the shape of an octagon. In other embodiments, the polygonal shaped base 216 may be in the shape of other polygons, such as, by way of example, a triangle, square, rectangle, pentagon, etc.

The polygonal shaped base 216 is operable to receive, for example, a token having a base of substantially similar shape and size as the polygonal shaped base 216. For example, as depicted in FIG. 2B, a puppy token 218 mounted on an octagonal base 220 of substantially the same size as the octagonal polygonal shaped base 216 may be placed in the receptacle 214. Thus, the play unit 110 that includes the receptacle 205 may operably read an identification code affixed to the underside or bottom of the octagonal base 220. The tapered sides 214 function to guide the proper placement of the puppy token 218 into the receptacle 205. The process of token insertion requires no or minimal mental activity in that a user merely pushes the token into the receptacle 214 through the circular cavity opening 212 and slightly rotates the token until the token fits in the polygonal shaped base 216. A similar easy placing procedure can be performed using, for example, the aforementioned central pole having a polygonal shape with a conical tip.

FIG. 3 illustrates selected components of a play unit 110, according to one embodiment. As depicted, the play unit 110 includes a receptacle 302, a micro-switch 304, a lens 306, a power amplifier 308, a linear illumination array 310, a battery 312, an antenna 314, a CMOS sensor 316, a microcontroller 318, a modulator 320, and a generator 322. The aforementioned components comprise an opto-electric barcode reader. Also depicted in FIG. 3 is a token 324 having a base with a substantially circular bottom having affixed, drawn, or imprinted on the bottom or underside of the base a rotation symmetrical barcode 326. The base of the token 324 is of the size to be placed into the receptacle 302.

As depicted, the micro-switch 304, the power amplifier 308, the linear illumination array 310, the CMOS sensor 316, the microcontroller 318, the modulator 320, and the generator 322 are coupled to the battery. The battery 312 generally functions as a power source providing power to the aforementioned components coupled to the battery 312. In another embodiment, the battery 312 may be replaced by a power source provided by, for example, a user computer 104 or other electronic appliance coupled to the play unit 110. In FIG. 3, dashed or broken lines depict the power supply connections, and solid or continuous lines depict signal and control connections.

The micro-switch 304 is connected to the linear illumination array 310. Placing the token 324 in the receptacle 302 depresses or activates the micro-switch 304 which initiates the reading of the rotation symmetrical barcode 326 from the bottom of the token 324. The micro-switch 304 activates the linear illumination array 310, and the linear illumination array 310 illuminates the rotation symmetrical barcode 326 through a slit or a barcode reader window (not depicted). In particular, a portion of the barcode rings or lines comprising the rotation symmetrical barcode 326 that is accessible through the slit is illuminated. In one embodiment, the slit is made sufficiently narrow to prevent misreads stemming from the curvature of the barcode rings in accord with the required sensitivity of the opto-electric barcode reader.

In another embodiment, a light source illuminating a photodiode may replace the micro-switch 304. Obstructing the light falling on the photodiode, for example, by placing the token 324 into the receptacle 302, may initiate the reading of the rotation symmetrical barcode 326.

Illuminating the rotation symmetrical barcode 326 causes the lens 306 to focus the image of the illuminated barcode onto a connected CMOS sensor 316. In one embodiment, the CMOS sensor 316 may be implemented using the LIS-1024 linear electro-optic CMOS sensor, which is available from Photon Vision Systems, USA. In a modification of this embodiment, a linear rod lens array can be used to minimize the overall barcode reader height.

The microcontroller 318 is connected to the CMOS sensor 316, and receives the signal output from the CMOS sensor 316. The microcontroller 318 is connected to the modulator 320, and the microcontroller 318 processes the signal from the CMOS sensor 316 to form an appropriate pulse sequence for the modulator 320. In one embodiment, the microcontroller 318 is the PIC12C607, which is available from Microchip, USA.

The modulator 320 modulates the received pulse sequence and applies the modulated signal to the connected generator 322. In one embodiment, the generator 322 is a radio frequency (RF) generator. The generator transforms the modulated signal to an RF signal that is input into the power amplifier 308. The power amplifier 308 amplifies the input signal and emits the amplified signal via the antenna 314. For example, the signal is transmitted to a receiver coupled to a user computer 104. In another embodiment, the signal may be transmitted to a user computer 104 that is coupled to the play station 110 by a wired connection.

In another embodiment, the play unit 110 may contain components and program logic that enriches the play unit 110 local control and feedback capabilities. For example, the play unit 110 may include components such as a display device (e.g., an LCD) and/or a speaker to display or present the requested multimedia content. The play unit 110 may also include a user interface that presents to the user basic control commands such as, by way of example, Play/Pause/Stop for music and videos, and Back/Forward/Home for electronic content that is displayed on the coupled display device, which enable the user to control the delivery of the multimedia content.

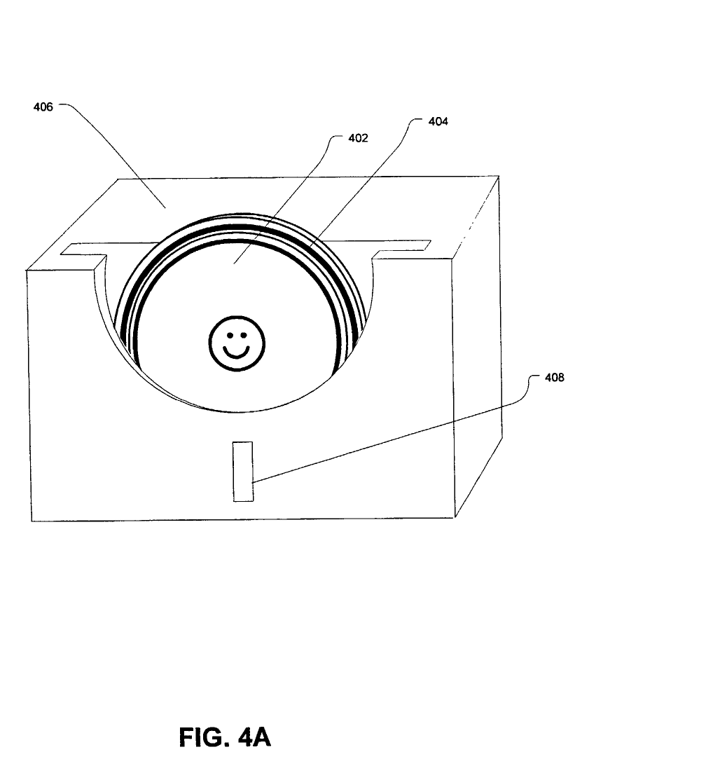

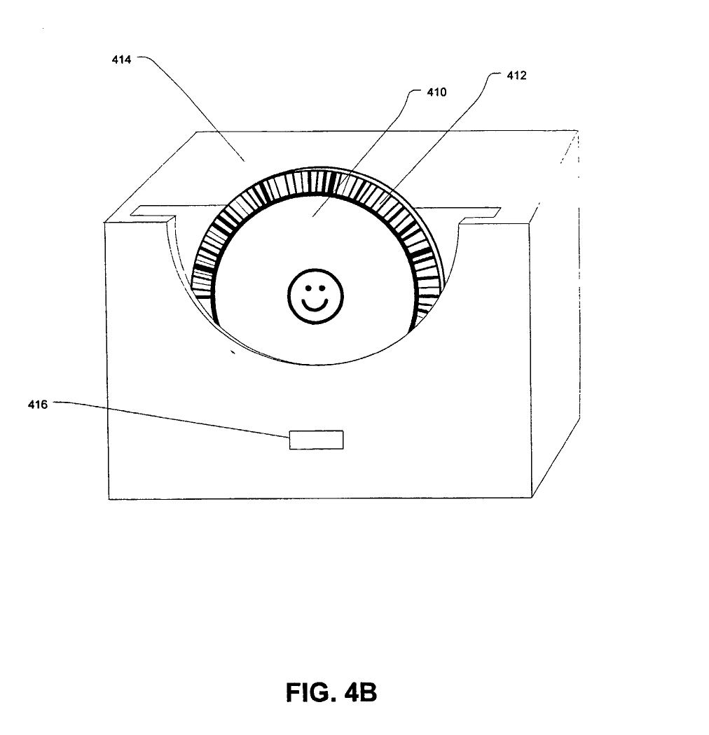

FIG. 4A is a representation of one embodiment of an exemplary token 402 bearing a barcode 404. In particular, the token 402 is a substantially circular disk-shaped object having affixed, drawn, or imprinted upon a potion of one side of the disk a barcode 404. The disk-shaped tokens are convenient for arranging CD-like and other collections. The barcode 404 is a concentric symmetrical code having concentric barcode lines comprising the concentric barcode positioned toward the outer rim of the token 402. As depicted, the token 402 is operably positioned in a receptacle 406 having a vertical linear sensor 408.

The receptacle 406 comprises a slit opening that provides access to a cavity. The slit opening is large enough to permit the insertion of a circular disk-shaped object into the cavity. The circular or polygonal disk-shaped object is placed edge first into the cavity through the slit opening. The bottom of the cavity (e.g., the end substantially opposite the slit opening) is keyed or shaped to receive a portion of the substantially circular rim of the inserted circular disk-shaped object. The angular symmetry of the token 402 and the slit and the cavity positioning facilitate the easy insertion of the token 402 into the receptacle 406. Thus, a user can easily place a token 402 into the receptacle 406 to request the multimedia content associated with the identification code represented by the barcode 404.

The vertical linear sensor 408 is operably positioned to read the concentric barcode lines comprising the barcode 404. In one embodiment, a picture may be affixed to one or both sides of the token 402. The picture is positioned not to obstruct the barcode 404 of the token 402. For example, a small child may identify or associate the type of multimedia content that is associated with the token 402 by the picture that is affixed to token 402. In another embodiment, the barcode 404 may be affixed to both sides of token 402. In still another embodiment, each side of the token 402 may have affixed a different barcode 404.

FIG. 4B is a representation of another embodiment of an exemplary token 410 bearing a barcode 412. In particular, the token 410 is a substantially circular disk-shaped object having affixed, drawn, or imprinted upon a potion of one side of the disk a barcode 412. The barcode 412 is a radial code positioned toward the outer rim of the token 410. As depicted, the token 410 is operably positioned in a cavity of a receptacle 414 having a horizontal linear sensor 416. The barcode 412 comprises radially-positioned barcode lines that are repetitive.

For example, a sequence of radial barcode lines that comprise a complete radial barcode (e.g., from a start of a barcode to an end of the barcode) is repeated to create the barcode 412. This enables the barcode 412 to be read by the horizontal linear sensor 410 having a length sufficient enough to detect and read a complete radial barcode without regard to the position of the token 410 in the cavity of receptacle 414. In another embodiment, the horizontal linear sensor 416 may be designed in a bent shape having a curvature radius substantially equal to that of the circular disk-shaped object rim designed to operably fit in the receptacle 414 cavity (e.g., the token 410). The sensor having such a curved shape contributes to eliminate the bar and space width aberrations that are inherent in the radial barcode lines comprising the barcode 412.

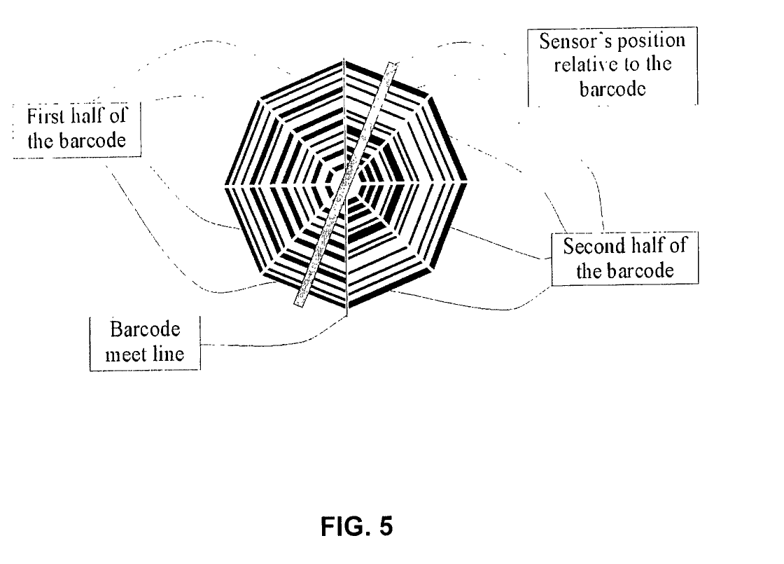

FIGS. 5 illustrates an exemplary polygonal barcode, according to one embodiment. In particular, the polygonal barcode is an octagonal barcode suitable for affixing, for example, on the underside of the octagonal base 220 (FIG. 2B). As depicted, the octagon is a regular octagon that provides eight distinctive positions. Each of the positions is shaped substantially as a triangle having one side extending from substantially the center of the octagon to a first vertex of the octagon, the second side extending from substantially the center of the octagon to an second vertex that is adjacent to the first vertex of the octagon, and the base extending from substantially the first vertex to the second vertex.

A radius length barcode can be printed in each of the eight distinctive positions of the octagon. Alternatively, as depicted in FIG. 5, four diameter length barcodes can be printed in the eight distinctive positions where the first half of each barcode is printed in a first distinctive position and the second half of each barcode is printed in a second distinctive position opposite the first distinctive position. Thus, the number of possible barcode combinations is squared or raised to the power of two. To read the octagonal shaped barcode, the code reader window 208 (FIG. 2A) is constructed, for example, on the diameter of the base of the cavity of the receptacle 204 (FIG. 2A) in a position to read two opposite sides of the octagon (e.g., two opposite distinctive positions). Only the portion of the barcode covered by the sensor's field of view are essential for the reading, whereas all the remaining surface of the triangles can be used for other purposes (e.g., printing a picture, etc.). The vertices of the polygon serve as guides, which do not allow the code reader window 208 (FIG. 2A) to read along the barcode meet-line depicted in FIG. 5.

In another embodiment, a polygonal-shaped disk can be used in a system, such as that depicted in FIG. 4A, where the bottom of the cavity is shaped to receive a portion of the polygonal-shaped disk.

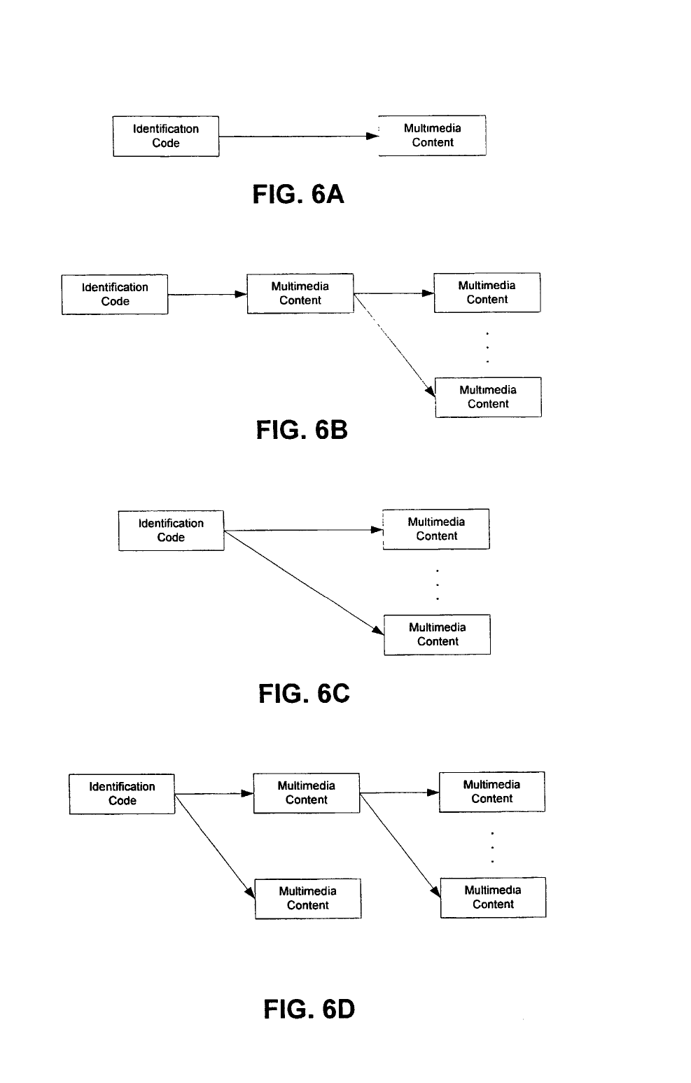

FIGS. 6A to 6D illustrate exemplary associations between identification codes and multimedia content, according to one embodiment. An identification code, in its simplest form, is associated with a multimedia content (FIG. 6A). As depicted in FIG. 6A, the multimedia content does not provide access to any other multimedia content. The multimedia content does not include, for example, hyperlinks or links (herein after collectively referred to as links) to other multimedia content. For example, this form of association may be useful in providing multimedia content that is safe for children (e.g., “child-safe” content).

FIG. 6B illustrates an identification code that is associated with a multimedia content, where the multimedia content provides access to other multimedia content. The multimedia content associated with the identification code includes, for example, one or more links to other multimedia content. The multimedia content associated with the identification code may also include search engines that function to provide access to other multimedia content. For example, this form of association may be useful in providing multimedia content to adults. This form of association may also be used to provide child-safe content to children, where the other accessible multimedia content is also child-safe and any provided search engine limits or restricts searches and search results to child-safe content.

FIG. 6C illustrates an identification code that is associated with more than one multimedia content. As depicted, each of the multimedia content does not provide access to any other multimedia content. In one embodiment, one or more user information items (e.g., user data, user preference data, user statistical data, user login, etc.) may be used in addition to the identification code to determine the multimedia content associated with the identification code that is appropriate for the user. For example, a token provider may create an identification code that is associated with one multimedia content suitable for users capable of reading. The same identification code is also associated with a second multimedia content suitable for users incapable of reading.

FIG. 6D illustrates an identification code that is associated with more than one multimedia content. As depicted, the identification code is associated with a first multimedia content that provides access to other multimedia content, and a second multimedia content that does not provide access to other multimedia content. Similar to FIG. 6C, one or more user information items may be used in addition to the identification code to determine the multimedia content associated with the identification code that is appropriate for the user.

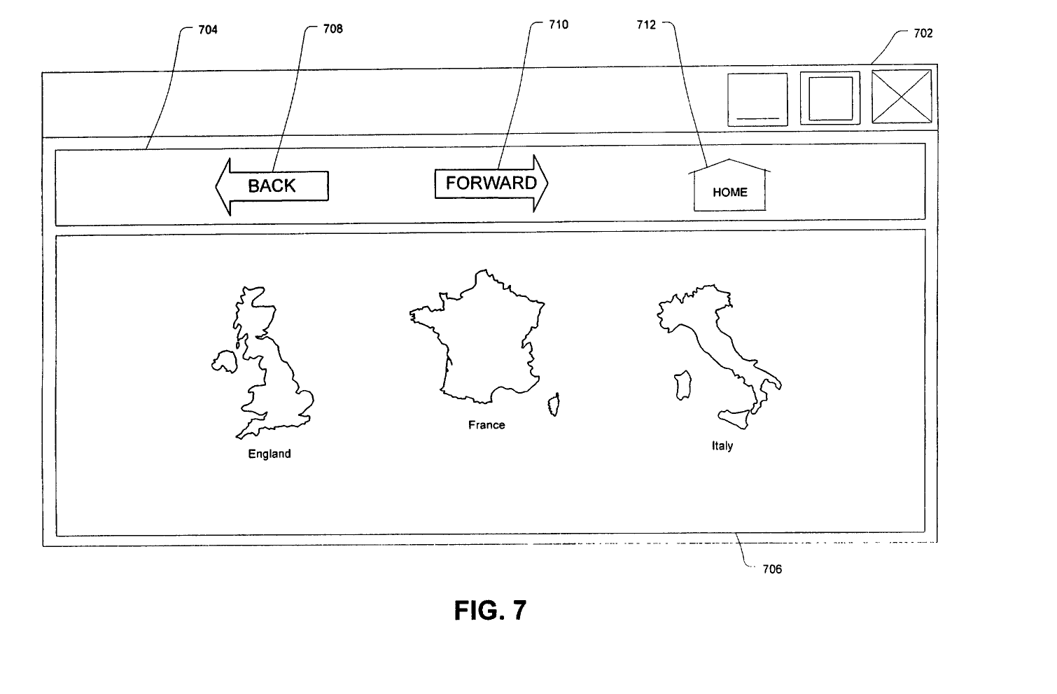

FIG. 7 illustrates an exemplary user interface 702 for children according to one embodiment. The user interface 702 may be implemented as, for example, an Internet type browser that is graphically rich but functionally restricted. As depicted, the user interface 702 includes a control panel 704 and a display area 706. The control panel 704 includes the following navigational buttons: a back button 708, a forward button 710, and a home button 712. The multimedia content is displayed in the display area 706.

In one embodiment, the navigational buttons 708, 710, and 712 are the only navigational commands provided by the user interface 702. The navigational buttons 708, 710, and 712 may function in a manner similar to the comparable navigational commands found in readily available Internet browsers such as, by way of example, the Netscape Navigator® developed by Netscape, Inc., and the Microsoft Internet Explorer® developed by Microsoft Corporation. The user interface 702 does not provide an interface for inputting an arbitrary Uniform Resource Locator (URL). Thus, the user interface 702 is suitable to deliver child-safe multimedia content. In other embodiment, some or all of the navigational buttons 708, 710, and 712 may not be provided.

In another embodiment, the multimedia content displayed through the user interface 702, either by using a token or activating one of the navigational buttons 708, 710, and 712, is filtered to remove content that is not suitable for delivery to children. In one embodiment, the physical bookmark server 102 may contain program logic that identifies multimedia content requested by a child user. The program logic may then remove content, such as, by way of example, links in the multimedia content, etc. which are not suitable for children. In another embodiment, user computer 104 may contain the program logic to filter and remove multimedia content that is not suitable for children.

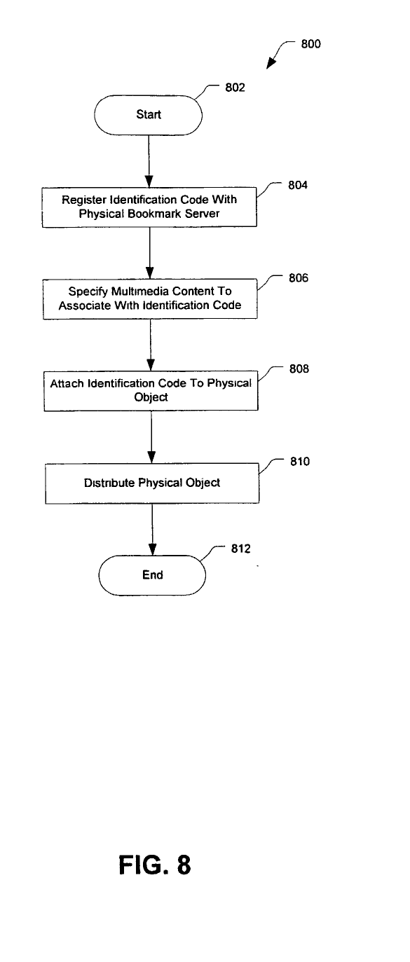

FIG. 8 illustrates a flow chart of an exemplary method 800 by which a physical bookmark is created, according to one embodiment. Beginning at a start step 802, a provider of a token (e.g., a manufacturer, a distributor, a product provider, a service provider, an advertiser, etc.) wants to provide users a token that functions as a physical bookmark. At a step 804, the provider registers an identification code with an administrator of the physical bookmark server 102. The identification code is the identification code the provider wants to affix to or otherwise associate with the token or tokens. In one embodiment, the physical bookmark server 102 may set, for example, a flag that indicates that the identification code is active (e.g., the identification code has been registered and is in use). At a step 806, the provider specifies to the administrator of the physical bookmark server 102 a multimedia content to associate with the identification code registered in prior step 804. The provider may specify, for example, a URL as an identifier that identifies the multimedia content.

In one embodiment, the physical bookmark server 102 may request additional information such as, by way of example, provider name, address, contact data, description of the token that will have the identification code, one or more descriptors describing the multimedia content (e.g., child-safe content, adult content, audio, video, text, graphics, animation, etc.), and the like. The provider may additionally provide filtering information to associate with the multimedia content. For example, assuming that the multimedia content provides access to content intended for adults, the provider may specify an age limit as one exemplary filter. In another example, assuming that the multimedia content provides access to an online community service (e.g., access to an online chat room, etc.) that is intended and set up to host female children living in Israel, the provider may specify an age requirement (e.g., less than 10 years old), a gender requirement (e.g., female), and a residence location requirement (e.g., Israel) as three exemplary filters.

In one embodiment, the physical bookmark server 102 creates and maintains the information submitted by the provider of the token in one or more databases. The physical bookmark server 102 uses this information to identify the multimedia content and to filter the multimedia content as necessary before delivery to a user.

In another embodiment, the provider of the token may specify more than one multimedia content to associate with the identification code registered in prior step 804. For example, the provider may specify a multimedia content in English to deliver to users residing in English speaking countries, and another multimedia content in Japanese to deliver to users residing in Japan. At step 808, the provider attaches the identification code to the tokens. For example, the tokens may be manufactured with the identification codes affixed to a portion of the token. At step 810, the provider distributes the tokens to, for example, the intended users, and ends at step 812.

Those of ordinary skill in the art will appreciate that, for this and other methods disclosed herein, the functions performed in the exemplary flow charts may be implemented in differing order. Furthermore, the steps outlined in the flow charts are only exemplary, and some of the steps may be optional, combined into fewer steps, or expanded into additional steps without detracting from the invention.

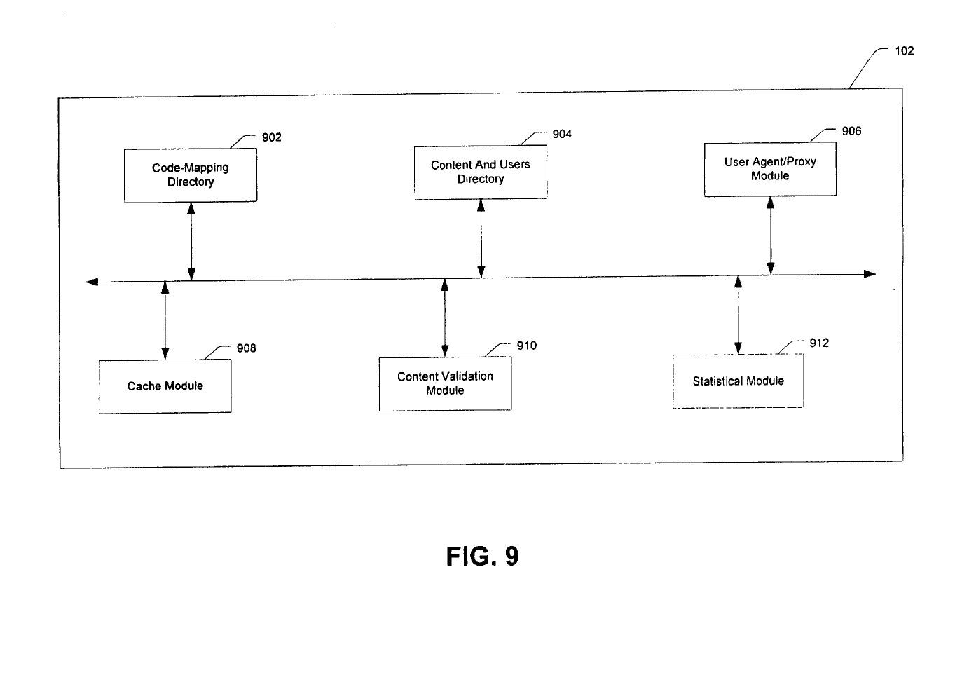

FIG. 9 illustrates selected components of a physical bookmark server 102, according to one embodiment. As depicted, the physical bookmark server 102 includes the following exemplary components: a code-mapping directory 902, a content and users directory 904, a user agent/proxy module 906, a cache module 908, a content validation module 910, and a statistical module 912. In one embodiment, the components 902, 904, 906, 908, 910, and 912 are coupled.

The code-mapping directory 902 generally functions to provide information about the association between multimedia content and identification codes in the physical bookmark server 102. In one embodiment, the code-mapping directory 902 is implemented as a database. The database contains records that store information regarding the association between the identification codes and its respective multimedia content or an identifier that identifies the multimedia content.

In one embodiment, a record in the code-mapping directory 902 contains, by way of example, a code value, a code descriptor, a content/service link descriptor, a owner descriptor, a cache descriptor, and a validity descriptor. The code value specifies an identification code. The code descriptor specifies the type of the identification code and the parameters necessary to edit and produce the code's physical representation (e.g., barcode type, permitted width variations, color, IR or B/W, printed or engraved, etc.). The content/service link descriptor identifies the multimedia content and/or service. The content/service link descriptor specifies how to obtain the multimedia content and/or service and may include, for example, an identifier and optionally a primary and a secondary URL.

The owner descriptor specifies the entity or party (e.g., the provider, the administrator of the physical bookmark server 102, etc.) owning and defining the specific code-mapping (e.g., to what content the code maps to, the start/end dates, etc.). The cache descriptor specifies whether the contents of the record in the code-mapping directory 902 can be cached (e.g., stored in local accessible memory), for how long, and what other code-mapping data should be cached. The validity descriptor specifies a start and/or end date or time (e.g., the date or time the particular identification code and multimedia content association starts or terminates), a valid flag (e.g., whether the particular identification code and multimedia content association is valid), a cancel flag (e.g., whether the particular identification code and multimedia content association has been canceled or terminated), and a cancellation time (e.g., the time the particular identification code and multimedia content association was cancelled).

The content and users directory 904 generally functions to manage the information regarding the multimedia content and/or services, the providers of the multimedia content and/or services, and the registered users (e.g., user accounts) in the physical bookmark server 102. In one embodiment, the content and users director, 904 is implemented as a database. The database contains records that store information regarding the multimedia content and/or services, the providers, and the registered users.

In one embodiment, the content and users directory 904 may maintain the registered user information in one or more records. For example, one record can contain a registered user's private data (e.g., name, address, credit card number, etc.), another record can contain the registered user's preferences (e.g., favorite colors, preferred music styles, etc.), still another record can contain the registered user's demographic data (e.g., age, sex, language, etc.), yet another record can contain the registered user's login information (e.g., login descriptor, password, etc.), another record can contain the registered user's system-wide access information (e.g., content filtering information), and still another record can contain the registered user's community rights information (e.g., online community services filtering information). In one embodiment, the login descriptor is unique within the physical bookmark server 102.

The content and users directory 904 may maintain the multimedia content and/or service information in one or more records. In one embodiment, the content and users directory also maintains and supports content dispatchers. A content dispatcher may support a user interface that is known to other components of the physical bookmark server 102, and contains program logic and filtering information to negotiate or validate a user for the multimedia content requested by the user.

The user agent/proxy module 906 generally functions to provide the physical bookmark services as described herein. The user agent/proxy module 906 contains program logic to process requests received from users who are using their tokens as physical bookmarks to access multimedia content. For example, the user agent/proxy module 906, in conjunction with the other components of the physical bookmark server 102, receives an identification code from a requestor (e.g., user account), identifies and retrieves a multimedia content associated with the received identification code, verifies the multimedia content as suitable for the requester, and transmits the multimedia content for delivery to the requester. In one embodiment, the user agent/proxy module 906 contains program logic to communicate over the Internet 108.

The cache module 908 generally functions to provide caching services in the physical object server 102. The cache module 902 may be implemented using, for example, a memory storage device or an addressable storage medium. The memory storage device and addressable storage medium may be in forms such as, by way of example, a random access memory (RAM), a static random access memory (SRAM), a dynamic random access memory (DRAM), an electronically erasable programmable read-only memory (EEPROM), a programmable read-only memory (PROM), an erasable programmable read-only memory (EPROM), hard disks, floppy disks, laser disk players, digital video disks, compact disks, video tapes, audio tapes, magnetic recording tracks, electronic networks, and other devices or technologies to transmit or store electronic content such as information and data.

The content validation module 910 generally functions to provide filtering of multimedia content. The content validation module 910 contains program logic that allows users to specify and configure filters that restrict access to the multimedia content. A user can use the content validation module 910 to specify one or more filters for a particular user account. The physical bookmark server 102 contains program logic that appropriately checks the specified filters to determine whether certain or all of a multimedia content requested by a user, and in particular, a user account, should be filtered and not delivered.

The statistical module 912 generally functions to maintain information and data regarding the use of the identification codes and the popularity of the multimedia content provided by the physical bookmark server 102. The statistical module 902 contains program logic that monitors, for example, the user accounts the users use to logon, the number of times each user account is used, the number of times each token is used, the number of times each multimedia content is accessed, and the like. The statistical module 912 may maintain the statistical information and data in one or more databases. In one embodiment, the statistical module 912 may support or provide an interface through which a user or a provider can obtain statistical information relevant to the respective user or provider.

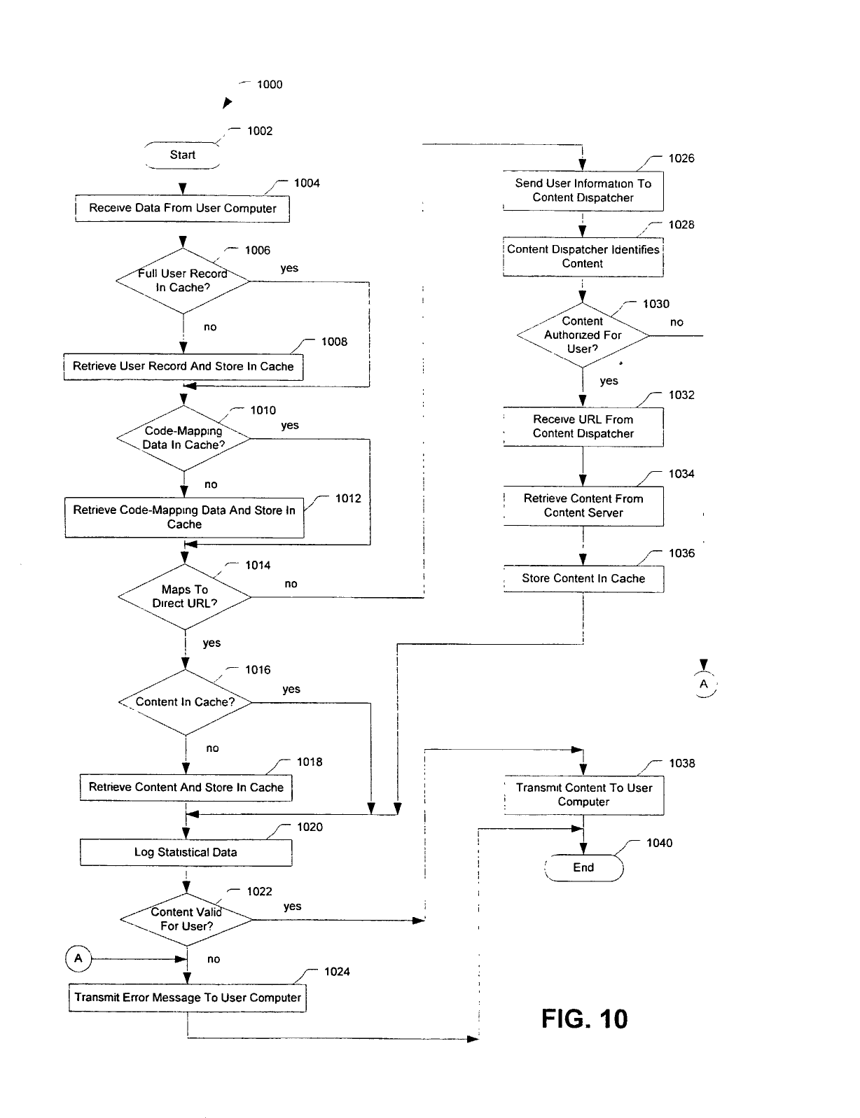

FIG. 10 illustrates a flow chart of an exemplary method 1000 by which a physical bookmark server 102 identifies content associated with a physical bookmark, according to one embodiment. Beginning at a start step 1002, a client application executing on a user computer 104 receives an identification code from a play unit 110 coupled to the user computer 104, and transmits a user login data and an identification code to the physical bookmark server 102. The user login data identifies the current user of the user computer 104 and the token having the identification code.

At step 1004, the user agent/proxy module 906 receives a request (e.g., a data packet, request packet, etc.) from the user computer 104. The request includes the login data and the identification code transmitted by the client application on the user computer 104. At step 1006, the user agent/proxy module 906 checks to determine if the necessary information and data regarding the user (e.g., the user account associated with the login data) to process the request is stored in cache memory, for example, the cache module 908. If the necessary user information is not stored in cache memory, then at step 1008, the user agent/proxy module 906 retrieves the necessary user information from, for example, the content and users directory 904, and stores the retrieved user information in cache memory.

If, at step 1006, the necessary user information was stored in cache memory, or after retrieving and storing the necessary user information in cache memory (step 1008), the user agent/proxy module 906 checks to determine if the code-mapping data necessary to determine the multimedia content that is associated with the identification code is stored in cache memory at step 1010. If the necessary code-mapping data is not stored in cache memory, then at step 1012, the user agent/proxy module 906 retrieves the necessary code-mapping data from, for example, the code-mapping directory 902, and stores the retrieved code-mapping data in cache memory.

If, at step 1010, the necessary code-mapping data was stored in cache memory, or after retrieving and storing the necessary code-mapping data in cache memory (step 1012), the user agent/proxy module 906 checks to determine if the identification code maps directly to a multimedia content at step 1014. In one embodiment, the user agent/proxy module 906 may check the content/service link descriptor to determine if the identification code maps directly to an identifier that identifies the multimedia content, such as, by way of example, a URL. If the identification code maps to, for example, a direct URL, the user agent/proxy module 906 can request or obtain the multimedia content using the URL.

If the identification code maps to a direct URL, the user agent/proxy module 906 determines if a local copy of the multimedia content identified by the direct URL is stored in cache memory at step 1016. If the identified multimedia content is not stored in cache memory, then at step 1018, the user agent/proxy module 906 uses the direct URL to retrieve the multimedia content from, for example, a content provider 106, and stores the retrieved multimedia content in cache memory.

If, at step 1016, the multimedia content was stored in cache memory, or after retrieving and storing the multimedia content in cache memory (step 1 018), the user agent/proxy module 906 logs statistical information and data at step 1020. In one embodiment, the user agent/proxy module 906 uses the statistical module 912 to log the information and data regarding, for example, the user, the token, and the multimedia content.

At step 1022, the user agent/proxy module 906 determines if the multimedia content is suitable for the user, and in particular, the user account associated with the login information. In one embodiment, the user agent/proxy module 906 uses the content validation module 910 and the filtering information associated with the user account to determine if the user is authorized to receive the multimedia content. If, at step 1022, the user agent/proxy module 906 determines that the multimedia content is not suitable for the user, then, at step 1024, the user agent/proxy module 906 transmits an error message to the requesting user computer 104, and ends at step 1040.

If, at step 1022, the user agent/proxy module 906 determines that the multimedia content is suitable for the user, then, at step 1038, the user agent/proxy module 906 transmits the multimedia content to the requesting user computer 104, and ends at step 1040. In another embodiment, the user agent/proxy module 906 may remove the unsuitable content from the multimedia content and transmit the filtered multimedia content to the user computer 104.

If, at prior step 1014, the identification code does not map to a direct URL, the user agent/proxy module 906 determines a content dispatcher to use to identify the multimedia content. In one example, the user agent/proxy module 906 uses the codemapping directory 902 to identify the proper content dispatcher. The content dispatcher contains program code to determine a multimedia content for the identification code using additional information such as, by way of example, user preference, user age, user language, the time of the request, and the like.

At step 1026, the user agent/proxy module 906 sends the necessary user information to the proper content dispatcher. At step 1028, the content dispatcher uses the user information to identify the multimedia content appropriate for the user and the identification code. At step 1030, the content dispatcher determines if the identified multimedia content is suitable/allowed for the user. For example, the multimedia content provider may have specified flags or descriptors that identify the nature of the multimedia content, the intended recipients, etc. If the multimedia content is not authorized for the user, then, at step 1024, the user agent/proxy module 906 transmits an error message to the user computer 104 and ends at step 1040.

If, at step 1030, the content dispatcher determines that the identified multimedia content is suitable for the user, the content dispatcher returns a URL for the multimedia content to the user agent/proxy module 906. In another embodiment, the content dispatcher can be integrated with a content server, thus eliminating the need to connect to a different server at step 1034.

At step 1032, the user agent/proxy module 906 receives the URL from the content dispatcher. At step 1034, the user agent/proxy module 906 uses the URL to retrieve the multimedia content from, for example, a content provider 106. At step 1036, the user agent/proxy module 906 stores the retrieved multimedia content in cache memory. If, at step 1032, the content dispatcher returned, for example, an identifier in cache memory to the multimedia content, or after storing the multimedia content (step 1036), the user agent/proxy module 906 continues processing from step 1020 described above.

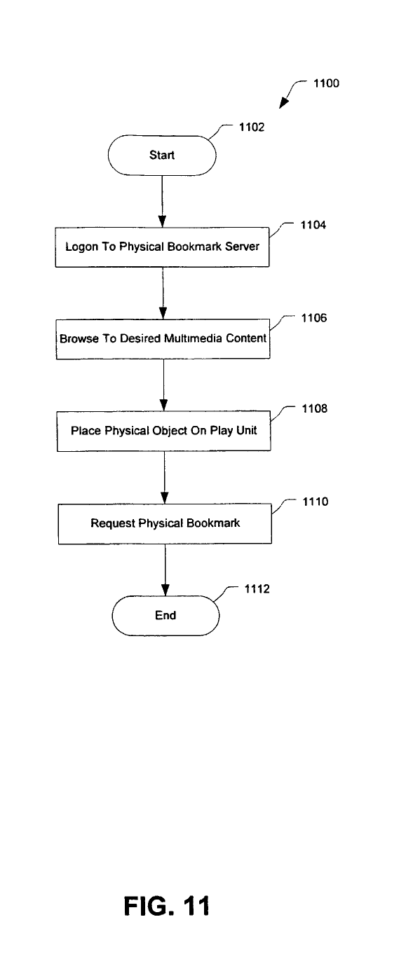

FIG. 11 illustrates a flow chart of an exemplary method 1100 by which a user creates a physical bookmark, according to one embodiment. Beginning at a start step 1102, a registered user wants to create a physical bookmark. For example, the user wants to associate multimedia content to a token bearing an identification code. At step 1104, the user uses, for example, his or her user computer 104 and logs on to the physical bookmark server 102. At step 1106, the user activates a browser and browses to the multimedia content (e.g., web page) the user wants the physical bookmark to reference.

At step 1108, the user places a token operably on the play unit 110 that is coupled to the user computer 104. The token used is the token the user wants to use as the physical bookmark. For example, the user may use a token that has some physical features related to the type of content bookmarked by the token. At step 1110, the user requests the creation of the physical bookmark (e.g., the association between the token and the multimedia content), and ends at step 1112.

In one embodiment, a user executes a client application on the user computer 104 to request the creation of the physical bookmark. The client application transmits to the physical bookmark server 102 the user's request to create the physical bookmark. The transmitted request may contain, without limitation, the user's login identification (e.g., the user account), the identification code read from the token, and the URL or other identification for the multimedia content. The physical bookmark server 102 may then create the requested physical bookmark by recording the association between the user account, the identification code, and the multimedia content. In another embodiment, the user may specify a login identification that is different from the one the user used to log on to the physical bookmark server 102.

Subsequently, the user may use the personally created physical bookmarks to access multimedia content associated with the physical bookmarks. In one embodiment, the physical bookmark server 102 may require that the user be logged on using the login identification that was used to create the physical bookmark. This enables a single token (identification code) to bookmark different multimedia content depending on the login identification.

As described herein, the present invention in at least one embodiment allows for the creating of a communication channel between a token provider and a token user. In one embodiment, a token and a play unit and the necessary software, are distributed for free or at a reduced price to create a loyal base of users (e.g., consumers/customer base). The tokens are associated with multimedia content specified by the token providers. The users use the tokens to access the associated multimedia content. Because the token providers control the multimedia content, the token providers have created a communication channel to the users of its tokens.

In at least one embodiment, the present invention enables a token provider to benefit from having direct access to statistical information regarding the use of the provider's tokens. The token provider may use the quantitative feedback for narrowing consumer targeting, to promote and augment the preference of products and services, while driving traffic to both online and offline shops or c-commerce sites.

The present invention, in at least one embodiment, enables a user to restrict access to multimedia content that meets certain criteria. For example, a parent who wants to control the content their children can access can restrict the multimedia content to childsafe content. Furthermore, a child-safe browser that restricts access to multimedia content may be provided for the children. Thus, the children can be prevented from retrieving arbitrary content.

In at least one embodiment, the present invention provides tokens that are adapted for use by children. The identification code reading procedure involves a simple operation by a user. The user is able to place the token on a play unit in an arbitrary angular orientation to cause the identification code to be read by the play unit. This allows small children to use the tokens to access the multimedia content. Furthermore, the tokens may be in shapes of toys the children are familiar with. The shape of the token may also provide an indication to the children of the type and nature of the associated multimedia content.

This invention may be provided in other specific forms and embodiments without departing from the essential characteristics as described herein. The embodiments described above are to be considered in all aspects as illustrative only and not restrictive in any manner. The following claims rather than the foregoing description indicate the scope of the invention.

What is claimed is:

1. An apparatus for accessing multimedia content using physical bookmarks comprising:
one or more tokens, each of the tokens comprises an identification code, wherein the identification code is associated with a multimedia content;
an input device comprising a receptacle, the input device operable to read a first identification code from a first token placed on the receptacle in an arbitrary angular orientation; and
a processing component coupled to the input device and operable to receive the first identification code, the processing component operable to deliver a first multimedia content associated with the first identification code.

2. The apparatus of claim 1, wherein the first identification code is affixed to a portion of the first token, the portion of the first token is shaped to be placed on the receptacle in an arbitrary angular orientation, thereby causing the first identification code to be read by the input device.

3. The apparatus of claim 2, wherein the shape of the portion of the first token having affixed to it the first identification code comprises a circular shape.

4. The apparatus of claim 2, wherein the receptacle comprises a positioning mechanism.

5. The apparatus of claim 2, wherein the receptacle's positioning mechanism comprises a physical border serving as a mouth of the receptacle and wherein the receptacle further comprising a cavity comprising a side wall and a bottom potion, the mouth having a substantially circular shape, the bottom portion being keyed to receive a polygonal-shaped object, wherein the side wall is tapered from the mouth to the bottom portion of the cavity.

6. The apparatus of claim 5, wherein the bottom portion of the receptacle is keyed to receive the portion of the first token in one of a plurality of orientations, each orientation of the first token having associated with it one of a plurality of identification codes.

7. The apparatus of claim 5, wherein the shape of the portion of the first token having affixed to it the first identification code comprises a polygon shape.

8. The apparatus of claim 7, wherein the receptacle comprising a polygonal shape.

9. The apparatus of claim 2, wherein the first identification code is a barcode and the input device comprises a linear electro-optic sensor positioned to read the bars of the barcode.

10. The apparatus of claim 2, wherein the first identification code is a concentric barcode.

11. The apparatus of claim 2, wherein the first identification code is a radial barcode having a plurality of repetitive segments.

12. The apparatus of claim 1, wherein the first identification code is a two dimensional optically detectable code and the input device comprises an area electrooptic sensor for reading it.

13. The apparatus of claim 1, wherein the first token is a substantially circular disk-shaped object having a first and second side and an edge, the substantially circular disk-shaped object having affixed to the first side the first identification code.

14. The apparatus of claim 13 further comprising a picture affixed to at least one side of the substantially circular disk-shaped object.

15. The apparatus of claim 13, wherein the first identification code is affixed to the first side and the second side.

16. The apparatus of claim 13 further comprising a second identification code being affixed to the second side of the substantially circular disk-shaped object.

17. The apparatus of claim 13, wherein the first identification code comprises a concentric symmetrical code.

18. The apparatus of claim 13, wherein the first identification code comprises a radial code having a plurality of repetitive segments.

19. The apparatus of claim 13, wherein the receptacle comprises a slit opening through which the substantially circular disk-shaped object is inserted edge first, the slit opening providing access to a cavity, the cavity operable to receive the substantially circular disk-shaped object.

20. The apparatus of claim 19, wherein the cavity comprises a shaped end substantially opposite the slit opening, the shaped end keyed to receive a potion of the edge of the substantially disked-shaped object.

21. The apparatus of claim 1, wherein the first multimedia content comprises a digital electronic document.

22. The apparatus of claim 1, wherein the processing component is operable to transmit the first identification code to a remote server, the remote server being operable to identify and transmit the first multimedia content associated with the first identification code to the processing component.

23. The apparatus of claim 1, wherein the processing component identifies one or more user preference information, the user preference information being used as a parameter to identify the first multimedia content.

24. The apparatus of claim 1, wherein the processing component is operable to retrieve the first multimedia content from a local memory device.

25. The apparatus of claim 1, wherein the local memory device comprises a removable memory device.

26. The apparatus of claim 1 further comprising a user interface operable to display the first multimedia content, the user interface enabling navigation to multimedia content accessible through a plurality of tokens and to any other Internet content.

27. The apparatus of claim 22, wherein the user interface being operable to enable the use of a restricted browser that does not provide navigation to arbitrary multimedia content, other than to the first multimedia content accessible through the use of the first token and a second multimedia content accessible through the first multimedia content.

28. A polygonal barcode comprising a plurality of barcodes, the polygonal barcode substantially shaped as a polygon, each of the plurality of barcodes placed inside one of a plurality of triangles created from the polygon wherein a first side of each triangle extends from the center of the polygon to a first vertex of the polygon and a second side of each triangle extends from the center of the polygon to a second vertex of the polygon and a base of each triangle extends along a first side of the polygon.

29. The polygonal barcode of claim 28, wherein each of the plurality of barcodes comprises a plurality of code lines being substantially parallel to the base of each triangle.

30. The polygonal barcode of claim 28, wherein the polygonal barcode comprises an even number of sides having an even number of triangles, wherein a first triangle and a second triangle being symmetrically opposite the first triangle comprises complementing parts of the same barcode.

31. A system for associating an identification code of a physical bookmark token to a multimedia content comprising:
a database comprising one or more mappings, each of the one or more mappings comprising a mapping of an identification code to an identifier associated with a multimedia content, wherein the identification code is associated with a token; and
a module coupled to the database and operable to receive a first identification code, the module operable to determine a first identifier mapped to the first identification code, the module further operable to retrieve a first multimedia content associated with the first identification code and to provide the first multimedia content.

32. The system of claim 31, wherein the token is a toy.

33. The system of claim 31, wherein the token is a game piece.

34. The system of claim 31, wherein the token is a promotional give-a-way.

35. The system of claim 31, wherein the token is distinguishable by texture.

36. The system of claim 31, wherein the token is distinguishable by size.

37. The system of claim 31, wherein the token is distinguishable by shape.

38. The system of claim 31, wherein the module is operable to transmit the first identifier to a content provider, the module is further operable to receive the first multimedia content from the content provider.

39. The system of claim 38, wherein the module is operable to cache the first multimedia content.

40. The system of claim 31, wherein the module is operable to receive a first user preference information, the module is operable to determine one or more user information items from the first user preference information, the module is further operable to determine the first identification from the one or more user information items and the first identification code.

41. The system of claim 31, wherein the first multimedia content provides access to a chat room.

42. The system of claim 31, wherein the first multimedia content provides access to an interactive game.

43. The system of claim 31, wherein the first identifier to the first identification code mapping is specified by a provider of the token.

44. The system of claim 31, wherein the first identifier to the first identification code mapping is specified by a user of the token.

45. The system of claim 31, wherein the first identifier comprises a URL.

46. The system of claim 31, wherein the first identification code is received from a remote device.

47. A method for creating physical bookmarks comprising:
providing a user identification to a physical bookmark server, the user identification identifies a user of the physical bookmark server;
specifying a URL;
placing a token in a position to be read by an input device, the token being associated with an identification code, wherein the input device receives and transmits the identification code to the physical bookmark server; and
requesting an association between the identification code and the user identification and the URL.

48. The method of claim 47 further comprising:
obtaining the identification code; and
affixing the identification code to the token.

49. The method of claim 47 further comprising placing the token on a receptacle of the input device in an arbitrary angular orientation.

50. A method for selecting and accessing multimedia content via physical bookmarks comprising:
detecting a token placed on a receptacle of an input device by a user, the token comprising an identification code;
reading the identification code associated with the token;
transmitting the identification code to a content server;
receiving a multimedia content from the content server, the multimedia content being identified by the identification code; and
delivering the multimedia content to the user.

51. The method of claim 50, wherein the multimedia content comprises electronic content that is safe for children.

52. The method of claim 50, wherein the token is a figurine.

53. The method of claim 50, wherein the token is a game piece.

54. The method of claim 50, wherein the token is a toy.

55. The method of claim 50, wherein the content server is a remote server.

56. The method of claim 50, wherein the content server comprises a local memory device.

57. The method of claim 50 further comprising:
determining user preference information associated with the user; and
transmitting the user preference information to the content server.

58. The method of claim 50 further comprising displaying the multimedia content on a display device.

59. The method of claim 50 further comprising transmitting the multimedia content through a speaker.

60. The method of claim 50 further comprising providing a child-safe user interface, wherein the multimedia content is delivered through the child-safe user interface.

61. The method of claim 60, wherein the child-safe user interface limits access to multimedia content and its linked multimedia content available through the use of a plurality of physical bookmark tokens.

62. A method for providing multimedia content associated with an identification code of a physical bookmark comprising:
providing a database comprising one or more mappings, each of the one or more mappings comprising a mapping of an identification code to an identifier associated with a multimedia content, wherein the identification code is associated with a token;
receiving a first identification code;
determining from the database a first identifier mapped to the first identification code;
retrieving a first multimedia content associated with the first identification code; and
providing the first multimedia content.

63. The method of claim 62, wherein first multimedia content is retrieved from cache.

64. The method of claim 62, wherein the first multimedia content is retrieved from a remote content provider.

65. The method of claim 62 further comprising caching the first multimedia content in local memory.

66. The method of claim 62 further comprising:
receiving a first user preference information; and
determining one or more user information items from the first user preference information, wherein the one or more user information items are a factor in determining the first identifier.

67. The method of claim 62, wherein the first identification code is received from a remote device.

68. The method of claim 67, wherein the remote device is a digital appliance.

69. A method for providing tokens associated with multimedia content comprising:
obtaining an identification code from a physical bookmark server provider;
registering the identification code with the physical bookmark server provider, the physical bookmark server provider indicating the identification code as active; and
specifying to the physical bookmark server provider an identifier to associate with the identification code, the identifier being a reference to a multimedia content, wherein the physical bookmark server provider creates an association between the identifier and the identification code.

70. The method of claim 69 further comprising:
affixing the identification code to one or more tokens; and
distributing the one or more tokens.
